(19) United States
(12) Patent Application Publication
(10) Pub. No.: US 2025/0061756 A1
(43) Pub. Date: Feb. 20, 2025

(54) ELECTRONIC LOCKSET HAVING MULTIPLE WIRELESS RADIOS

(71) Applicant: ASSA ABLOY Americas Residential Inc., New Haven, CT (US)

(72) Inventors: Subramanian Muthu, Lake Forest, CA (US); James Creighton Hart, Huntington Beach, CA (US); Charles Dougherty, South Pasadena, CA (US)

(21) Appl. No.: 18/806,175

(22) Filed: Aug. 15, 2024

Related U.S. Application Data
(60) Provisional application No. 63/519,736, filed on Aug. 15, 2023.

(51) Int. Cl. G07C 9/00; G07C 9/27

(52) U.S. Cl. CPC G07C 9/00309; G07C 9/00571; G07C 9/27; G07C 2009/00642; G07C 2209/02; G07C 2209/62

(57) ABSTRACT

In general, this disclosure is directed to an electronic lockset having more than one radio to provide remote access and/or control. In some embodiments, systems and methods for setting up configuring the electronic lockset having more than one radio are disclosed. In some embodiments, the electronic lockset includes features for maintaining remote access when an active wireless radio of the electronic lockset fails. In some embodiments, the electronic lockset is configured to perform a set of features, including techniques for implementing a feature that is not implemented in a protocol of the active wireless radio. In some embodiments, systems and methods for saving battery power and extending battery life for an electronic lockset are disclosed.

### CROSS-REFERENCE TO RELATED APPLICATIONS

This application claims priority to U.S. Provisional Patent Application No. 63/519,736 filed Aug. 15, 2023, the disclosure of which is incorporated herein by reference in its entirety.

### BACKGROUND

Electronic locks have become increasingly popular as a secure and convenient solution for access control in various settings, such as residential, commercial, and industrial properties. These locks employ a range of technologies, including keypads, touchscreens, RFID cards, and biometric sensors, to authenticate users and grant or deny access based on predefined criteria.

One development in electronic lock technology is the integration of remote access features, which enable authorized users to control and monitor the lock from a distance using an internet-enabled device, such as a smartphone, tablet, or computer. This remote access capability allows users to grant temporary access to guests, receive notifications of access events, and manage user credentials without the need for physical presence at the lock location.

Despite the advancements in electronic lock technology, there remain challenges related to the design, functionality, and user experience of these locks. Some electronic locks may have limited battery life, complicated installation processes, or inadequate security features, which can undermine their effectiveness and appeal to potential users. Additionally, the remote access features of existing electronic locks may suffer from connectivity issues, latency, or insufficient compatibility with various devices and platforms, hindering their ease of use and accessibility.

### SUMMARY

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

In general, this disclosure is directed to an electronic lockset having more than one radio to provide remote access and/or control. In some embodiments, systems and methods for setting up, configuring, and/or operating the electronic lockset having more than one radio are disclosed. In some embodiments, the electronic lockset includes features for maintaining remote access when an active wireless radio of the electronic lockset fails by waking up a second wireless radio. In some embodiments, the electronic lockset is configured to perform a set of features, including techniques for implementing a feature that is not implemented in a protocol of the active wireless radio. In some embodiments, one wireless radio is configured to primarily communicate with a third-party cloud based application and a second wireless radio is configured to primarily communicate with a cloud based application of the manufacturer of the electronic lockset. In some embodiments, systems and methods for saving battery power and extending battery life for an electronic lockset are disclosed.

One aspect is an electronic lockset comprising an exterior subassembly, an interior subassembly including a control circuit and a motor actuatable by the control circuit, a high-bandwidth wireless radio configured to connect to a high-bandwidth wireless network, a low-power wireless radio configured to connect to a low-power wireless network, and a latch operatively connected to the interior subassembly, the latch being engageable by the motor to move the electronic lockset between a locked state and an unlocked state, wherein the control circuit monitors connection of at least one of the high-bandwidth wireless network and the low-power wireless network and places one of the high-bandwidth wireless radio and the low-power wireless radio in a power saving mode while maintaining remote access capability.

Another aspect is a user computing device for configuring an electronic lockset, the user computing device comprising at least one processor, and at least one memory storing instructions which, when executed by the at least one processor, cause the user computing device to wirelessly pair with the electronic lockset, determine whether a local environment is equipped for the electronic lockset to connect to a high-bandwidth wireless network and/or a low-power wireless network, and provide credentials to enable the electronic lockset to connect to the high-bandwidth wireless network and/or the low-power wireless network.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates an operating environment for remotely accessing an electronic lock, in accordance with some embodiments of the present disclosure.

FIG. 2 is a schematic representation of the electronic lockset mounted to the door, in accordance with some embodiments of the present disclosure.

FIG. 3 is a system-flow diagram illustrating an example method for configuring the electronic lockset for remote access, in accordance with some embodiments of the present disclosure.

FIG. 4 is a system-flow diagram illustrating an example method for configuring the electronic lockset for remote access, in accordance with some embodiments of the present disclosure.

FIG. 5 illustrates an example method for configuring an electronic lockset for remote access, in accordance with some embodiments of the present disclosure.

FIG. 6 illustrates an example method for determining a default network for the electronic lockset, in accordance with some embodiments of the present disclosure.

FIG. 7 illustrates an example user interface of a client application, in accordance with some embodiments of the present disclosure.

FIG. 8 illustrates an example method for maintaining remote access when a low-power wireless network fails, in accordance with some embodiments of the present disclosure.

FIG. 9 illustrates an example method for monitoring high-bandwidth network connectivity while an electronic lockset is in a low power state, in accordance with some embodiments of the present disclosure.

FIG. 10 illustrates an example method of using a second low-power wireless protocol when a first low-power network connection fails, in accordance with some embodiments of the present disclosure.

FIG. 11 illustrates an example method for performing proxy reporting from an electronic lockset.

FIG. 12 illustrates an example operating environment for providing remote access to the electronic lockset, in accordance with some embodiments of the present disclosure.

FIG. 13 illustrates an example method for waking up a high-bandwidth network to provide an updated access code to the electronic lockset, in accordance with some embodiments of the present disclosure.

FIG. 14 illustrates an example method for transitioning an electronic lockset into a low battery mode.

FIG. 15 illustrates an example system-flow diagram illustrating a process for updating an access code of an electronic lockset with multiple wireless radios.

FIG. 16 illustrates an example system-flow diagram illustrating a process for enabling door sense of an electronic lockset with multiple wireless radios.

FIG. 17 illustrates an example system flow-diagram illustrating a process for enabling a secure mode at an electronic lockset with multiple wireless radios.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

In general, this disclosure is directed to an electronic lockset having more than one radio to provide remote access and/or control. In some embodiments, systems and methods for setting up, configuring, and/or operating the electronic lockset having more than one radio are disclosed. In some embodiments, the electronic lockset includes features for maintaining remote access when an active wireless radio of the electronic lockset fails by waking up a second wireless radio. In some embodiments, the electronic lockset is configured to perform a set of features, including techniques for implementing a feature that is not implemented in a protocol of the active wireless radio. In some embodiments, one wireless radio is configured to primarily communicate with a third-party cloud based application and a second wireless radio is configured to primarily communicate with a cloud based application of the manufacturer of the electronic lockset. In some embodiments, systems and methods for saving battery power and extending battery life for an electronic lockset are disclosed.

In some embodiments, the electronic lockset includes two wireless radios, including a high-bandwidth wireless radio (e.g., a Wi-Fi radio) and a low-power wireless radio (e.g., Matter/Thread, Bluetooth, or Zigbee radio). In some embodiments the low-power wireless radio is a multi-protocol radio (e.g., a Thread/Bluetooth enabled radio). In some embodiments, the electronic lockset uses the low-power wireless radio when operating in a default state and wakes-up the high-bandwidth wireless radio when required. In some embodiments, the high-bandwidth wireless radio is used when the connection via the low-power wireless radio fails. In some embodiments, the high-bandwidth wireless radio is used when a user is attempting to use a feature which is not implemented in a protocol of the low-power wireless network. For example, the protocol for Thread may not include the capability to perform a feature, and the electronic lockset will wake-up a high-bandwidth wireless radio to provide the feature.

In some embodiments, remote access provides several key features for operating an electronic lockset, especially in relation to Smart Home and IoT systems. Some of these features allow an authorized user of the lock to check the status of the lock, operate the lock, provide secure access to a guest, etc. The electronic lockset disclosed can support multiple protocols for wireless communication including (Wi-Fi, BLE, Thread, etc.). In some embodiments, the electronic lockset disclosed provides failover connectivity when one method of wireless access fails. In some embodiments, the electronic lockset is configured to preserve battery power by placing one or more wireless radios in a power saving mode (e.g., turning off the radio or putting the wireless radio in an inactive/sleep state). For example, operating two radios simultaneously will consume more battery power and will reduce the battery life. Accordingly, this disclosure describes methods to minimize or eliminate the simultaneous operation of both radios to prolong the battery life.

In some embodiments, the electronic lockset is IPv6 (Internet protocol version 6) enabled, where the larger address space of the IPV6 protocol allows the electronic lockset to have a unique IP address facilitating direct communication without relying on any specific intermediary devices/services. In some embodiments, fully leveraging the IPV6 protocol requires compatibility with at least one networking hub (e.g., an IPV6 enabled router) local to the electronic lockset that is capable of connecting to the Internet and/or compatibility with an Internet Service Provider (ISP).

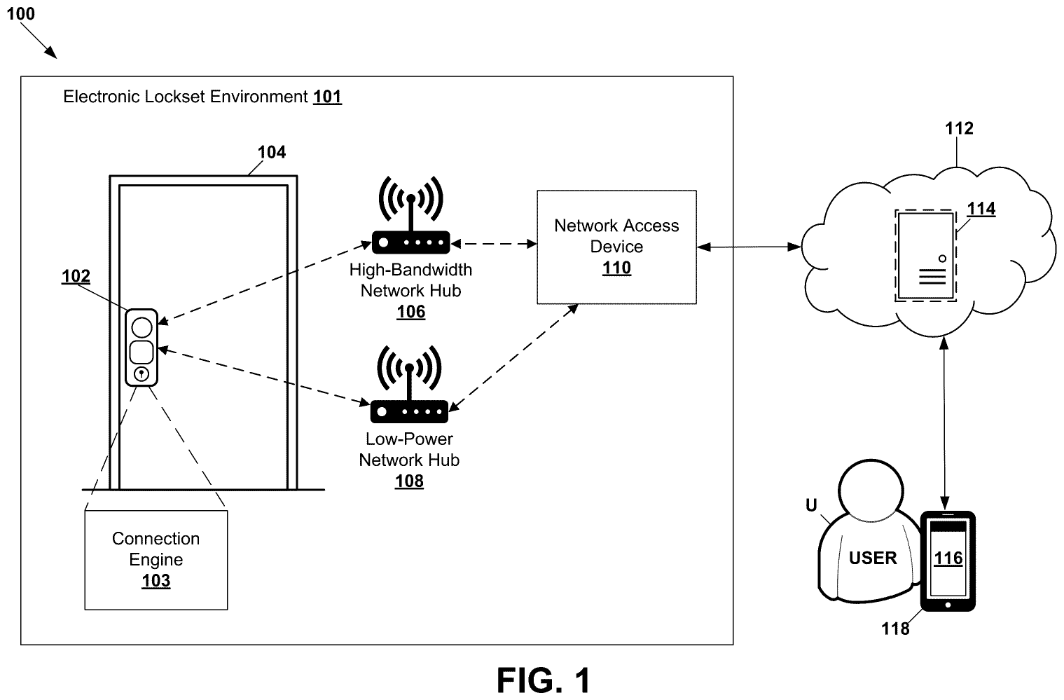

FIG. 1 illustrates an operating environment 100 for remotely accessing an electronic lockset 102 in which aspects of the present disclosure may be implemented. The operating environment 100 includes an electronic lockset environment 101, a cloud environment 112, and a user computing device 118. Also shown is a server 114 operating within the cloud environment 112. The user computing device 118 is operating a client application 116. Also shown is a user U.

The electronic lockset environment 101 includes an electronic lockset 102 configured to operate a connection engine 103, a high-bandwidth network hub 106, a low-power network hub 108, and a network access device 110.

As shown, the electronic lockset environment 101 includes a door 104 comprising an electronic lockset 102 (also referred to as a wireless electronic lockset) installed at a premises. The electronic lockset 102 is operative or configured to lock and unlock a door 104 based on an authentication process. For example, by a passcode, biometric, or via a client application 116 operating a user computing device 118, including information associated with a sensed event (e.g., time and description of the sensed event, or remote feed of sensor data obtained via one or more sensors). In some examples, the exterior assembly can include one or more sensors by which a unique enrollment code may be received. The electronic lockset 102 may be actuable from either an input interface or from the client application 116 installed on a computing device (e.g., the user computing device 118).

The electronic lockset 102 is configured to wirelessly connect to a high-bandwidth network hub 106 and/or a low-power network hub 108. In some embodiments, the electronic lockset 102 operates a high-bandwidth wireless radio to wirelessly connect to the high-bandwidth network hub 106 and a low-power wireless radio to connect to the low-power network hub 108.

In some embodiments, the electronic lockset 102 is configured to operate a connection engine 103. The connection engine 103 is configured to manage the remote connectivity of the electronic lockset 102. In some embodiments, the connection engine 103 is configured to optimize the power usage of the electronic lockset 102. For example, the connection engine 103 is configured to place the high-bandwidth wireless radio in a power saving mode when the electronic lockset 102 is connected to the low-power network. In some embodiments, the connection engine 103 will activate the high-bandwidth wireless radio in response to detecting a connection failure with the low-power wireless network or when high bandwidth wireless radio is required to perform a feature. Example methods and features of the connection engine 103 are disclosed herein.

The electronic lockset environment 101 includes a network access device 110. The network access device 110 facilities communication with a network including one or more public networks, such as the Internet. In some embodiments, the network access device 110 includes a router and/or modem. In some embodiments, the router acts as the high-bandwidth network hub 106 and/or the low-power network hub 108. In some of these embodiments, the router is a Wi-Fi router. The network access device 110 facilities remote access of the electronic lockset 102 from the user computing device 118 via the server 114 in the cloud environment 112.

In some embodiments, the high-bandwidth network is a Wi-Fi network. In alternative embodiments, the high-bandwidth network is a cellular network e.g. 4G LTE or 5G. Other high-bandwidth networking technologies can also be used in different embodiments.

In some embodiments, the low-power network hub 108 is a device that is part of a low power mesh network. In some embodiments, the low-power network hub 108 is a Matter enabled device. In some embodiments, the electronic lockset 102 connects to the low-power network hub 108 via Thread protocol. In some embodiments, other low-power networking technologies are used, such as Bluetooth, BLE, Zigbee, etc.

The server 114 may be a physical server or a virtual server hosted in a cloud environment 112. In some examples, the electronic lockset 102 is operative or configured to communicate with the server 114. The server 114 may be operative or configured to expose one or more application programming interfaces (APIs) that may be used communications between the server 114 and the user computing device 118 and between the server 114 and the electronic lock 102. In some examples, the server 114 may be operative and/or configured to generally manage user accounts associated with the electronic lock 102 and to relay instructions between authorized mobile devices and the electronic lockset 102.

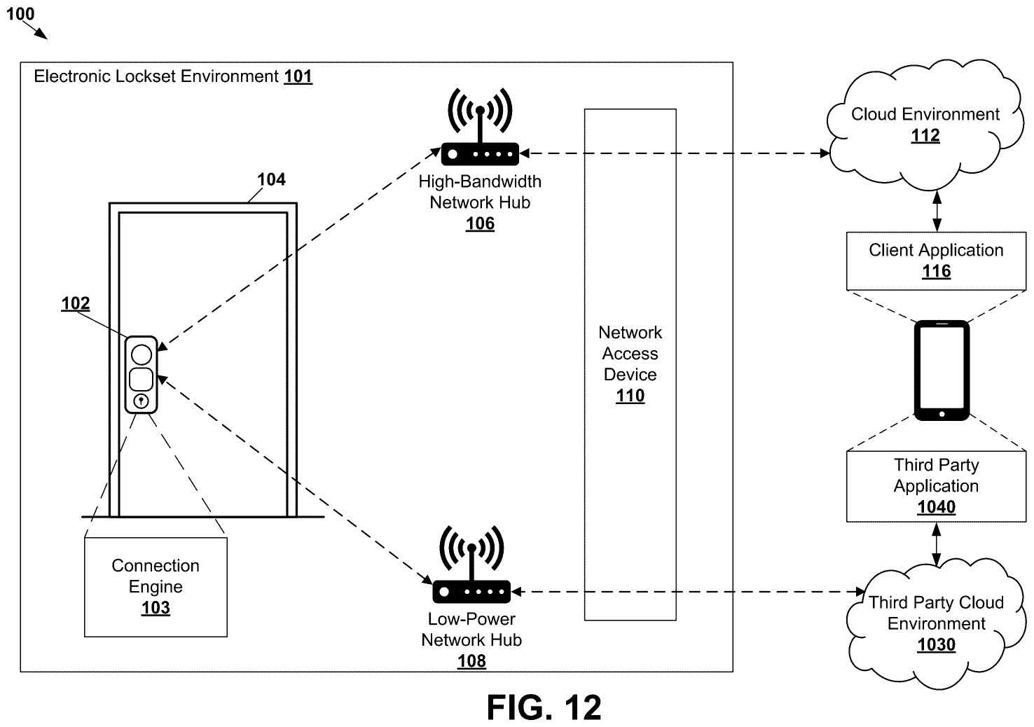

The user computing device 118 operates a client application 116 to allows the user U to access various features of the electronic lockset 102. In some embodiments, the user computing device 118 may operate multiple applications to remotely access the electronic lockset 102. For example, one application may be associated with the manufacturer of the lock 102 and another application may be provided by a third party (e.g., as part of a smart home platform). An example embodiment is illustrated in FIG. 12.

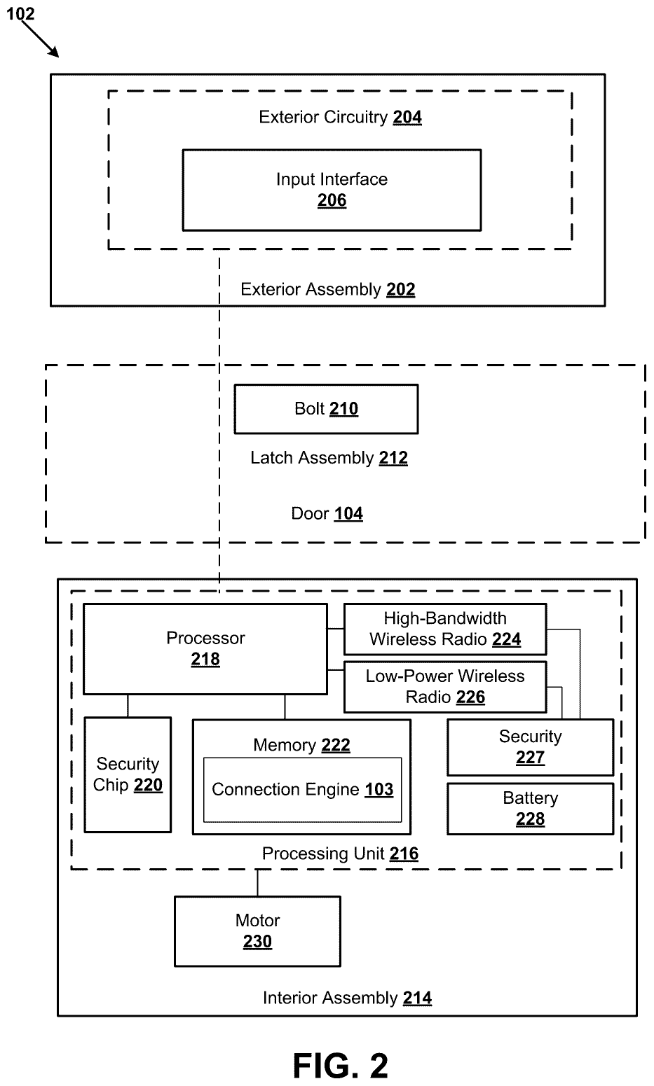

FIG. 2 is a schematic representation of the electronic lockset 102 mounted to the door 104. An exterior assembly 202, a latch assembly 212, and an interior assembly 214 of the electronic lock 102 are shown.

The exterior assembly 202 is shown to include the input interface 206, which may include a keypad, a biometric sensor, and an exterior antenna usable for communication with a user computing device. In some examples, the exterior assembly 202 can include one or more sensors by which conditions exterior to the door 104 can be sensed. In response to such sensed conditions, notifications may be sent by the electronic lockset 102 to a server, and/or the user computing device including information associated with a sensed event (e.g., time and description of the sensed event, or remote feed of sensor data obtained via the sensor). In some examples, the exterior assembly 202 can include one or more sensors by which the unique enrollment code may be received. The exterior assembly 202 includes exterior circuitry 204 to electrically connect input interface 206 (along with any other exterior electrical components) with a processing unit 216.

The interior assembly 214 includes the processing unit 216. The interior assembly 214 can also include a motor 230.

As shown, the processing unit 216 includes at least one processor 218 communicatively connected to a security chip 220, a memory 222, a high-bandwidth wireless radio 224, low-power wireless radio 226, and a battery 228. The processing unit 216 is located within the interior assembly 214 and is capable of operating the electronic lockset 102, (e.g., by actuating the motor 230 to actuate a bolt 210).

Additionally, in some embodiments, one or both of the high-bandwidth wireless radio 224 and the low-power wireless radio 226 are associated with a security chip 227, for example, a cryptographic circuit capable of storing cryptographic information and generating encryption keys usable to generate certificates for communication with other systems (e.g., the user computing device 118 described above in connection with FIG. 1).

In some examples, the processor 218 can process signals received from a variety of devices to determine whether the electronic lockset 102 should be actuated. Such processing can be based on a set of preprogramed instructions (i.e., firmware) stored in the memory 222. In certain embodiments, the processing unit 216 can include a plurality of processors 218, including one or more general purpose or specific purpose instruction processors. In some examples, the processing unit 216 is configured to capture an input interface input event from a user and store the input interface input event in the memory 222. In other examples, the processor 218 may receive signals from an exterior antenna (not shown), an interior antenna (not shown), or a motion sensor (not shown) (e.g., a vibration sensor, gyroscope, accelerometer, motion/position sensor, or combination thereof) and can validate received signals in order to actuate the electronic lockset 102. In still other examples, the processor 218 may receive signals from one of the high-bandwidth wireless radio 224 and the low-power wireless radio 226 to determine whether to actuate the electronic lockset 102. In some embodiments, the low-power wireless radio 226 includes a multi-protocol enabled communication chip. For example, the communication chip may be configured to interface with the Thread protocol and/or the Bluetooth protocol.

In some examples, the interior assembly 214 also includes the battery 228 to power the electronic lockset 102. In one example, the battery 228 may be a standard single-use (disposable) battery. Alternatively, the battery 228 may be rechargeable. In still further embodiments, the battery 228 is optional altogether, replaced by an alternative power source (e.g., an AC power connection).

The interior assembly 214 may also include the motor 230 that may be capable of actuating the bolt 210. In use, the motor 230 may receive an actuation command from the processing unit 216, which causes the motor 230 to actuate the bolt 210 from a locked position to an unlocked position or from the unlocked position to the locked position. In some examples, the motor 230 actuates the bolt 210 to an opposing state. In some examples, the motor 230 receives a specified lock or unlock command, where the motor 230 may only actuate the bolt 210 if the bolt 210 is in the correct position. For example, if the door 104 is locked and the motor 230 receives a lock command, then no action may be taken. If the door 104 is locked and the motor 230 receives an unlock command, then the motor 230 may actuate the bolt 210 to unlock the door 104.

In some embodiments, the processing unit 216 may include a security chip 220 that is communicatively interconnected with one or more instances of the processor 218. In some examples, the security chip 220 can, for example, generate and store cryptographic information usable to generate a certificate usable to validate the electronic lockset 102 with a remote system, such as the server 114 or mobile device (e.g., the user computing device 118) described above in connection with FIG. 1.

The memory 222 can include any of a variety of memory devices, such as using various types of computer-readable or computer storage media. A computer storage medium or computer-readable medium may be any medium that can contain or store the program for use by or in connection with the instruction execution system, apparatus, or device. By way of example, computer storage media may include dynamic random access memory (DRAM) or variants thereof, solid state memory, read-only memory (ROM), electrically crasable programmable ROM, and other types of devices and/or articles of manufacture that store data. Computer storage media generally includes at least one or more tangible media or devices. Computer storage media can, in some examples, include embodiments including entirely non-transitory components.

In some embodiments, the memory 222 stores instructions for a connection engine 103 which are executable by the processor 218. The connection engine 103 is configured to manage the remote connectivity of the electronic lockset 102. As discussed in reference to FIG. 1, in some embodiments, the connection engine 103 operates to maintain remote connectivity while minimizing power usage. In some examples, the connection engine 103 is configured to place the high-bandwidth wireless radio 224 in a power saving mode when the electronic lockset 102 is connected to the low-power network. In some embodiments, the connection engine 103 will activate the high-bandwidth wireless radio 224 in response to detecting a connection failure with the low-power wireless network or when high-bandwidth wireless radio 224 is required to perform a feature. In some examples, the connection engine 103 will reestablish a connection with a low power wireless network and place the high-bandwidth wireless radio 224 in a power saving mode. Other example features and methods are disclosed herein.

The processing unit 216 can include one or more wireless radios including a high-bandwidth wireless radio 224 and a low-power wireless radio 226. The high-bandwidth wireless radio 224 may provide a Wi-Fi interface and the low-power wireless radio 226 may include an interface to communicate with a Matter enabled device (e.g., with the Thread protocol). Alternatively, the low-power wireless radio 226 may provide a Bluetooth or BLE interface. In some embodiments, RF circuits can be included as well. In the example shown, the high-bandwidth wireless radio 224 and the low-power wireless radio 226 can communicate with a remote device. In some examples, the processing unit 216 can communicate with the user computing device 118 and the server 114 via one of the high-bandwidth wireless radio 224 and the low-power wireless radio 226, as described above in connection with FIG. 1. In some examples, Wi-Fi 6 technologies are used by the electronic lock 102. In some embodiments, the processing unit 216 is configured to enable with Internet Protocol Version 6 (IPv6), including software instructions and required hardware components to implement IPv6 functionality.

As should be appreciated, in alternative embodiments, other wireless protocols can be implemented as well, via one or more additional wireless interfaces. In some examples, the electronic lockset 102 can wirelessly communicate with external devices through a desired wireless communications protocol. In some examples, an external device can wirelessly control the operation of the electronic lockset 102, such as operation of the bolt 210. The electronic lockset 102 can utilize wireless protocols including, but not limited to, the IEEE 802.11 standard (Wi-Fi®), the IEEE 802.15.4 standard (Zigbee® and Z-Wave®), the IEEE 802.15.1 standard (BLUETOOTH®), a cellular network, a wireless local area network, near-field communication protocol, and/or other network protocols. In some examples, the electronic lockset 102 can wirelessly communicate with networked and/or distributed computing systems, such as may be present in a cloud-computing environment.

In a particular embodiment, the processor 218 may receive a signal via the low-power wireless radio 226 from a user computing device for communication of an intent to actuate the electronic lockset 102. The processor 218 can also initiate communication with a server via the low-power wireless radio for purposes of validating an attempted actuation of the electronic lockset 102, or receiving an actuation command to actuate the electronic lockset 102. In some embodiments, the electronic lock 102 is enrolled in a third-party application and is able to communicate with a cloud application of a third-party application via the low-power wireless radio 226.

In a particular embodiment, the processor 218 may receive a signal via the high-bandwidth wireless radio 224 for communication of a unique enrollment code, which the processor 218 may be instructed to present for validating a guest user. Additionally, the processor 218 may receive a signal from a server via the high-bandwidth wireless radio 224 for communication of a successful validation of the unique enrollment code and authorization to complete enrollment of the guest user.

Additionally, various other settings and features can be viewed and/or modified via the high-bandwidth wireless radio 224 and the low-power wireless radio 226 from a server. As such, a user can access accounts associated with the electronic lockset 102, such as to view and modify settings of that lock, which may then be propagated from the server (or a third-party server) to the electronic lockset 102.

The latch assembly 212 is typically at least partially mounted in a bore formed in the door 104. The term “outside” is broadly used to mean an area outside the door 104 and “inside” is broadly used to denote an area inside the door 104. With an exterior entry door, for example, the exterior assembly 202 may be mounted outside a building, while the interior assembly 214 may be mounted inside a building. With an interior door, the exterior assembly 202 may be mounted inside a building, but outside a room secured by the electronic lockset 102, and the interior assembly 214 may be mounted inside the secured room. The electronic lockset 102 is applicable to both interior and exterior doors 104.

The latch assembly 212 is shown to include a bolt 210 that is movable between an extended position (locked) and a retracted position (unlocked). Specifically, the bolt 210 is configured to slide longitudinally and, when the bolt 210 is retracted, the door 104 is in an unlocked state. When the bolt 210 is extended, the bolt 210 may protrude from the door 104 into a doorjamb to place the door 104 in a locked state. The motor 230 may be energized to retract or extend the bolt 210 of the latch assembly 212.

The electronic lockset 102 may be used on both interior and exterior doors 104. Described above are non-limiting examples of a wireless electronic lockset 102. It should be noted that the electronic lockset 102 may be used on other types of doors 104, such as a garage door or a doggie door, or other types of doors that require an authentication process to unlock (or lock) the door.

In some embodiments, the electronic lockset 102 is made of mixed metals and plastic, with engineered cavities to contain electronics and antennas. For example, in some embodiments, the lock 102 utilizes an antenna near the exterior face of the lockset, designed inside the metal body of the lockset 120 itself. The metal body can be engineered to meet strict physical security requirements and also allow an embedded front-facing antenna to propagate RF energy efficiently.

### I. Remote Access Configuration

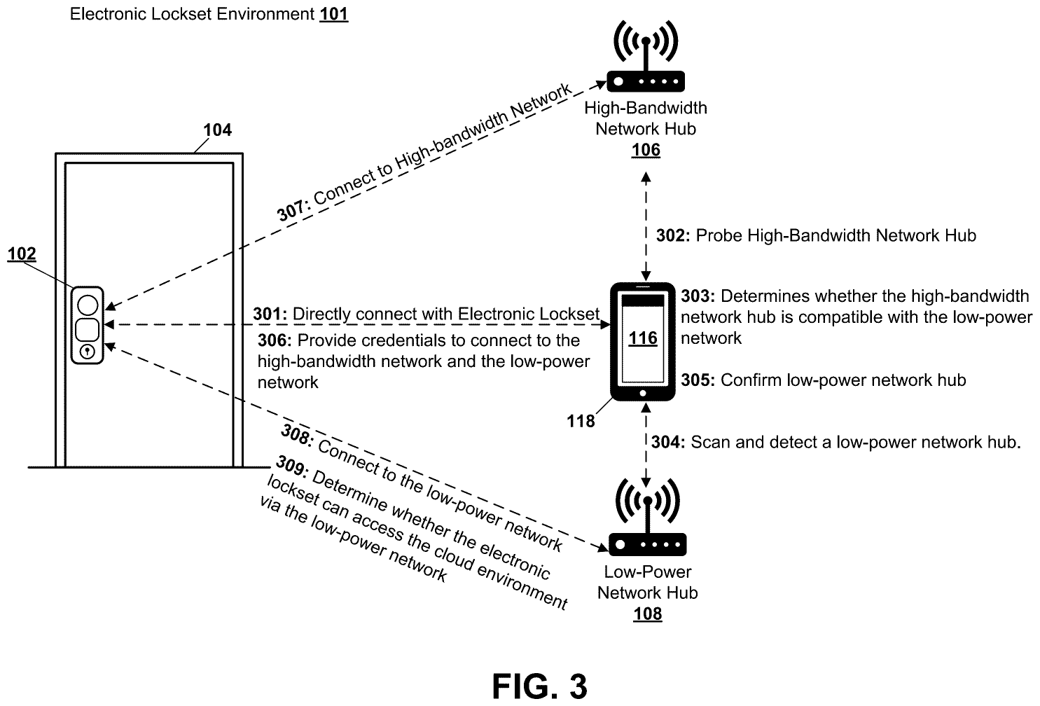

FIGS. 3-7 illustrate example systems, methods, and user interfaces for configuring remote access for the electronic lockset 102. Typically, the configuration for remote access is managed by the user computing device 118 using a client application 116, for example as shown in FIG. 1.

In some embodiments, to provide the electronic lockset features disclosed herein requires the configuration of the electronic lockset with multiple radios at the time of installation. For example, the failover features and to provide a feature set with protocol parody require the electronic lockset to be configured to connect to multiple wireless networks. For example, the electronic lockset may be configured/installed to connect to a Wi-Fi network and a Matter based network. In many typical embodiments, an application operating on the user computing device performs operations and receives inputs to detect a state of a local environment including accessible local networks and provides instructions to the electronic lock for connecting to the selected networks. In some embodiments, multiple applications are used where a third-party application is used to connect via the low-power network (e.g., such as a smart home platform application). In further embodiments, the electronic lockset may perform operations to detect the state of the local environment.

In one example, a user purchases the electronic lockset and downloads a client application associated with the electronic lockset. The client application guides the user to connect to each of the networks (e.g., a high-bandwidth wireless network and the low-power wireless network). The client application includes an algorithm which will scan for available network hubs and determine compatibility with different networking protocols. In an alternative example, the electronic lockset scans for available network hubs. This may be the case when the electronic lockset includes radios for that are not available in the user computing device on which the client application executes. For example, the user computing device may not include a radio to detect a Matter based network or the Matter based network may otherwise be unavailable to the user computing device, so the electronic lockset may scan for a Matter based network and inform the client device if a Matter based network is discovered. In some embodiments, the scan also determines if the lockset will have sufficient signal strength from different wireless networks. In some embodiments, the electronic lockset recommends a default wireless network. For example, the low-power wireless network will likely be selected for a user that wishes to optimize for battery life. The user will input the network credentials into the client application, which are wirelessly provided to the electronic lockset, allowing the electronic lockset to connect to the one or more wireless networks. In some embodiments, a user also enrolls the electronic lockset with a network using a third-party application. Once configured, the electronic lockset will put one of the wireless radios in a standby mode (sometimes referred to as a power saving mode).

FIG. 3 is a system-flow diagram illustrating an example method for configuring the electronic lockset 102 for remote access. The system-flow diagram shown includes an electronic lockset environment 101 with a high-bandwidth network hub 106 and a low-power network hub 108. In some examples, the high-bandwidth network hub 106 may be a Wi-Fi router that does not support IPv6 (e.g., to provide connectivity via Matter using the Thread protocol). In the system shown, the environment 101 includes a separate low-power hub 108 which is enabled to provide connectivity via a low-power network.

The example method shown includes eight steps. In some embodiments, the steps are performed in a different order than shown and one or more of the steps may be optional. The method shown is performed after the client application 116 is installed on the user computing device 118. In some embodiments, the method is performed after the electronic lockset 102 is installed and connected to a charged power source. The method illustrated includes steps 301, 302, 303, 304, 305, 306, 307, 308, and 309.

At step 301, the user computing device 118 directly connects with the electronic lockset 102. In some embodiments, the user computing device 118 connects to the electronic lockset 102 via a Bluetooth pairing process. In some embodiments, the electronic lockset 102 only activates a Bluetooth enabled radio prior to the configuration of the electronic lockset 102 and the radio.

At step 302, the user computing device 118 probes the high-bandwidth network hub 106 in order to receive compatibility information for the high-bandwidth network hub 106. In typical embodiments, the high-bandwidth network hub 106 is a Wi-Fi router and the compatibility information relates to whether the Wi-Fi router is IPV6 enabled. In some embodiments, step 302 is performed by the client application 116 in the background as the user computing device 118 pairs with the electronic lockset 102.

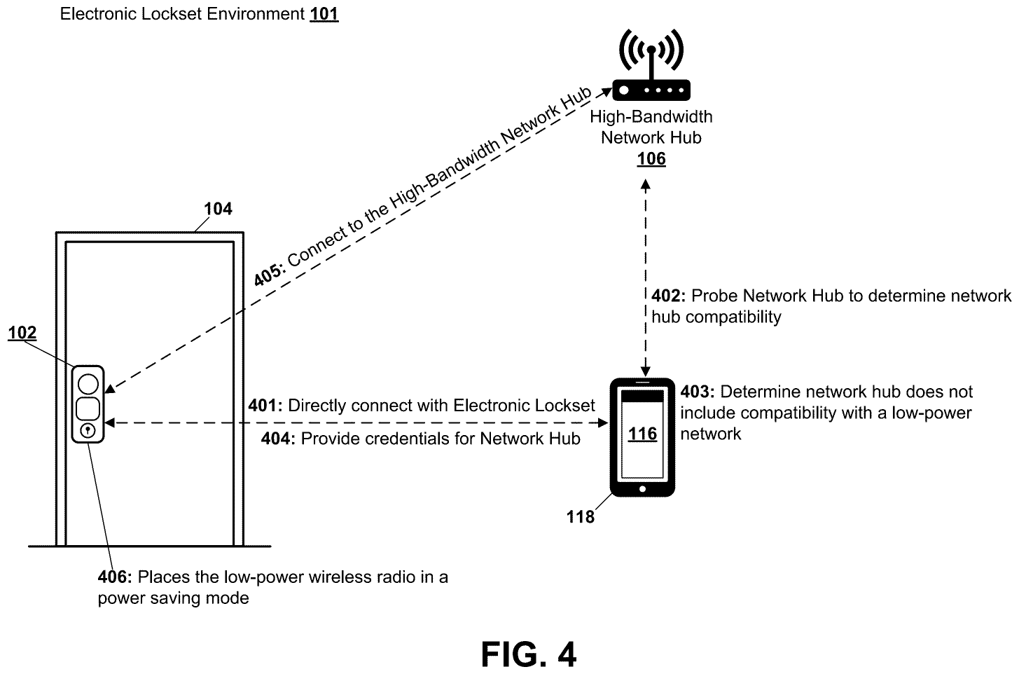

At step 303, the user computing device 118 determines whether the high-bandwidth network hub 106 is compatible with the low-power network. In some embodiments, the low-power network uses one or more Matter enabled devices to create a low-power mesh network. In some of these embodiments, the Wi-Fi router must be IPV6 enabled to provide remote connectivity via the low-power network. In some embodiments, the user computing device 118 may determine that the Wi-Fi router is enabled with an IPV6 setting which is turned off. In some examples, the user computing device 118 may query the router model information to determine compatibility and provide instructions to the user on how to turn on the IPV6 setting. In some examples, the client application 116 may determine the router is too old and suggest the user update the router. In some examples, if compatibly with the low-power network is not possible, the method continues to Wi-Fi only enrollment (e.g., as shown in FIG. 4).

At step 304, the user computing device 118 scans and detects a low-power network hub 108. In some embodiments, the low-power network hub 108 is a border router. Examples of border routers include Apple TV, Google home hub, Amazon Alexa devices, or any other Matter enabled device. In some embodiments, the client application 116 may request the user select a specific border router (e.g., if multiple options are available). In other embodiments, a low power-network hub 108 is selected based on signal strength.

At step 305, the user computing device 118 confirms the low-power network hub 108. In some embodiments, as part of the confirmation, the user enrolls the electronic lockset 102 in a third-party application associated with the low-power network hub 108 (e.g., such as Apple Homekit, Amazon Alexa, Google Assistant, Samsung SmartThings, etc.).

At step 306, the user computing device 118 provides credentials to connect the electronic lockset 102 to the high-bandwidth network (at step 307) and the low-power network (at step 308). After the electronic lockset 102 is connected to both networks, the electronic lockset 102 determines whether it can access the cloud environment at step 309. In some embodiments, step 309 includes probing the ISP for IPV6 support (in some embodiments from the electronic lockset 102 and in other embodiments from the user computing device 118). In some embodiments, the electronic lockset 102 cannot access the cloud environment of the manufacturer of the lockset 102 but can access a cloud environment of a third party (e.g., see FIG. 12).

In some embodiments, where the low-power wireless network is a Matter network, the user provides inputs to enroll the Matter enabled electronic lockset 102 into the Matter based network. In some embodiments, the Matter network is configured to operate with more than one ecosystem including a lock manufacturer ecosystem and a third-party ecosystem. Different enrollment procedures and configurations may be used depending on the types of ecosystems. Additionally, different feature sets may be available via different ecosystems. For example, the third-party ecosystem may not have access to more sensitive features (e.g., such as changing a passcode of the electronic lockset 102) but may have access to less sensitive information (e.g., such as a current lock state of the electronic lockset 102).

In some embodiments, enrolling the lockset 102 with the Matter network includes: (1) placing the border router and electronic lockset 102 in an enrollment mode; and (2) scanning a QR code of a border router with the user computing device 118, where the user computing device 118 decodes and provides the encoded ID to the electronic lockset 102 to connect the electronic lockset 102 to the border router. This process may be repeated to enroll the lockset 102 with other ecosystems.

In alternative embodiments, the electronic lockset 102 may scan and detect one or both of the high-bandwidth network and the low-power network or the corresponding hubs 106, 108. In an example, the user computing device 118 may not include a radio to connect to a low-power network, such as a Matter based network. In this example, the electronic lockset 102 may detect the low-power network (e.g., by using a low-power radio) and inform the client application of the low-power network and the low-power hub 108.

FIG. 4 is a system-flow diagram illustrating an example method for configuring the electronic lockset 102 for remote access. The electronic lockset environment 101 operates similar to the electronic lockset environment 101 illustrated in FIG. 3. In the example shown, the electronic lockset environment 101 includes a high-bandwidth network hub 106 which is not compatible with the low-power network. For example, the high-bandwidth network hub 106 may be a Wi-Fi router which does not support IPv6 and is not compatible with a Matter based network.

The method illustrated includes steps 401, 402, 403, 404, 405, and 406. At step 401, the user computing device 118 directly connects (e.g., pairs) with the electronic lockset 102. At step 402, the user computing device 118 probes the high-bandwidth network hub 106 to receive compatibility information. At step 403, the user computing device 118 determines that the high-bandwidth network hub 106 is not compatible with the low-power network. Based on this determination, the electronic lockset 102 proceeds with only a high-bandwidth network operation. At step 404, the user computing device 118 provides credentials for the high-bandwidth network hub 106. In some embodiments, the credentials include a network name and password. At step 405, the electronic lockset 102 connects to the high-bandwidth network. At step 406, the electronic lockset 102 places the low-power wireless radio in a power saving mode.

In some embodiments, the client application 116 will recommend the user upgrade their network for compatibly in order to improve battery life while maintaining remote access and control.

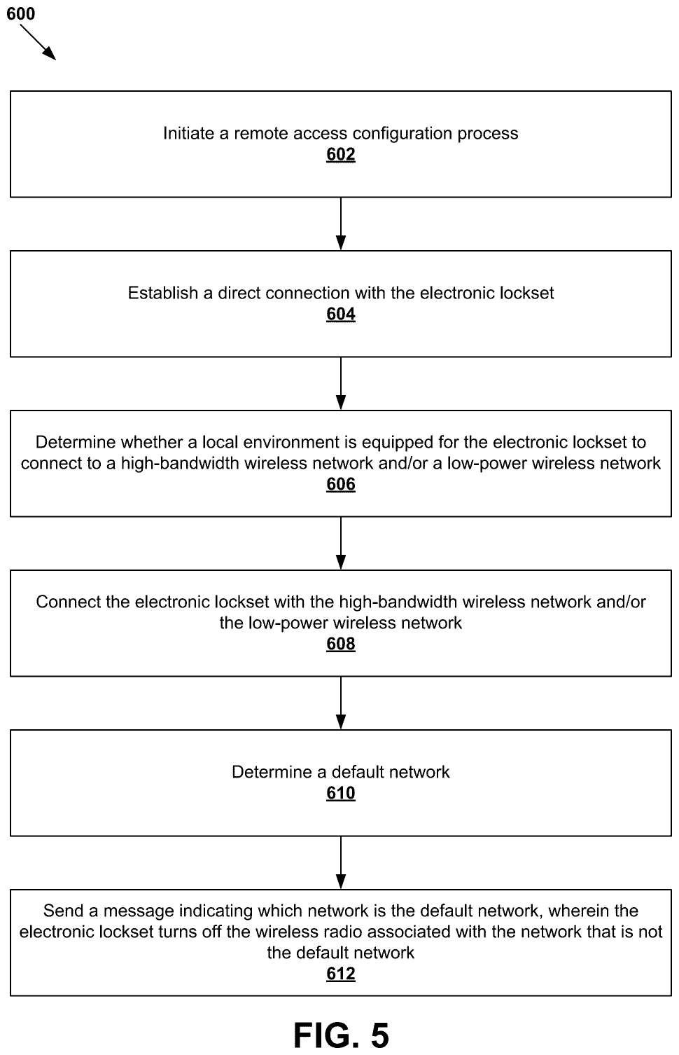

FIG. 5 illustrates an example method 600 for configuring an electronic lockset for remote access. In some embodiments, the method 600 is performed on a user computing device as part of the operation of a client application. The method 600 includes the operations 602, 604, 606, 608, 610, and 612.

The operation 602 initiates a remote access configuration process with an electronic lockset. In some embodiments, the operation 602 is preformed after the electronic lockset is installed. In some embodiments, the client application receives inputs initiating a process to connect the electronic lockset to one or more wireless networks.

The operation 604 establishes a direct connection with the electronic lockset. In some embodiments, the direct connection uses a low-power wireless protocol such as Bluetooth low energy (BLE).

The operation 606 determines whether the local environment is equipped for the electronic lockset to connect to a high-bandwidth network and/or a low-power network.

In some embodiments, the operation 608 checks a Wi-Fi router (e.g., the high-bandwidth network hub) to determine if the router is enabled with IPV6. In some embodiments, a user may be instructed to adjust a setting of the router to enable IPV6. In other embodiments, the router is not compatible, and the electronic lockset proceeds with high-bandwidth only connection. If the Wi-Fi router is compatible, the user computing device probes for border routers compatible with the low-power network (e.g., a Matter enabled device, such as a smart speaker, smart TV, home hub, etc.). When multiple border-routers are available, a user may select a border router to connect the electronic lockset to or the client application may automatically select a border router. If no border routers are available, the configuration continues with high-bandwidth wireless operation. If a border router is possible, the lockset probes the ISP for IPV6 support. If the ISP does not support IPv6, then the lockset may be unable to connect to the cloud environment but may still have remote access via a third-party application (see FIG. 12). If the ISP does support IPV6, then the electronic lockset can be configured to connect with a cloud environment to provide remote access using both the high-bandwidth wireless network (e.g., via Wi-Fi) and the low-power wireless network (e.g., via Matter/Thread).

The operation 608 connects the electronic lockset with the high-bandwidth network and/or the low-power network. In some embodiments, the client application provides credentials to connect/enroll in both the high-bandwidth wireless network and the low-power wireless network.

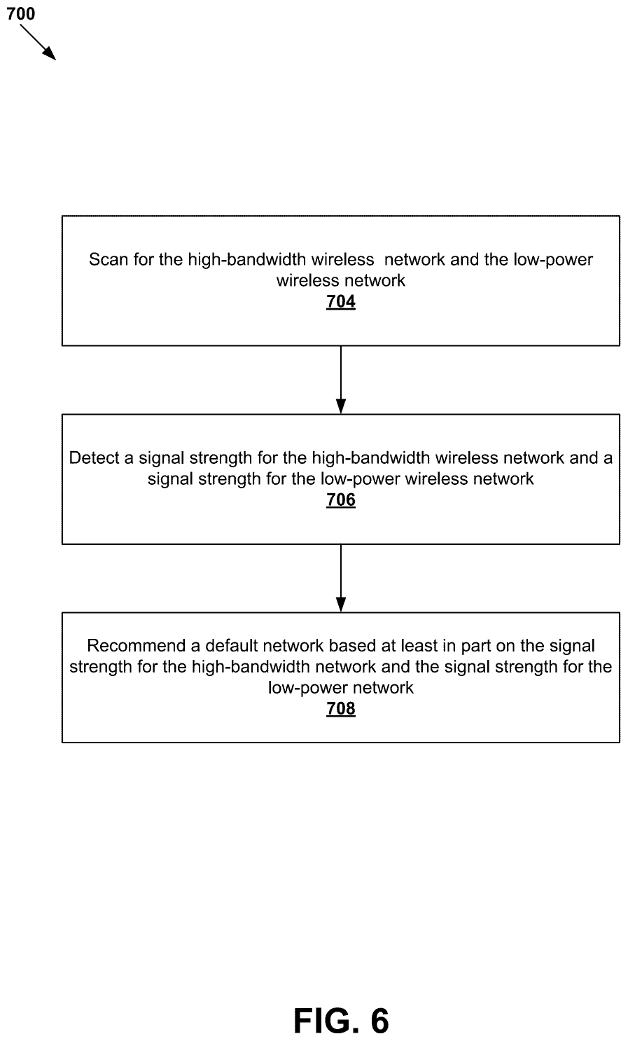

The operation 610 determines a default network. In some embodiments, the default network is determined by the method 700 illustrated and described in reference to FIG. 6.

The operation 612 sends a message indicating which network is the default network, wherein the electronic lockset turns off the radio associated with the network that is not the default network. In typical embodiments, if the electronic lockset is able to access the cloud via both networks, the low-power network may be the default network in order to preserve battery power.

FIG. 6 illustrates an example method 700 for determining a default network for the electronic lockset. In some embodiments, the method 700 is performed on a user computing device as part of the operation of a client application. The method 700 includes the operation 704, 706, and 708.

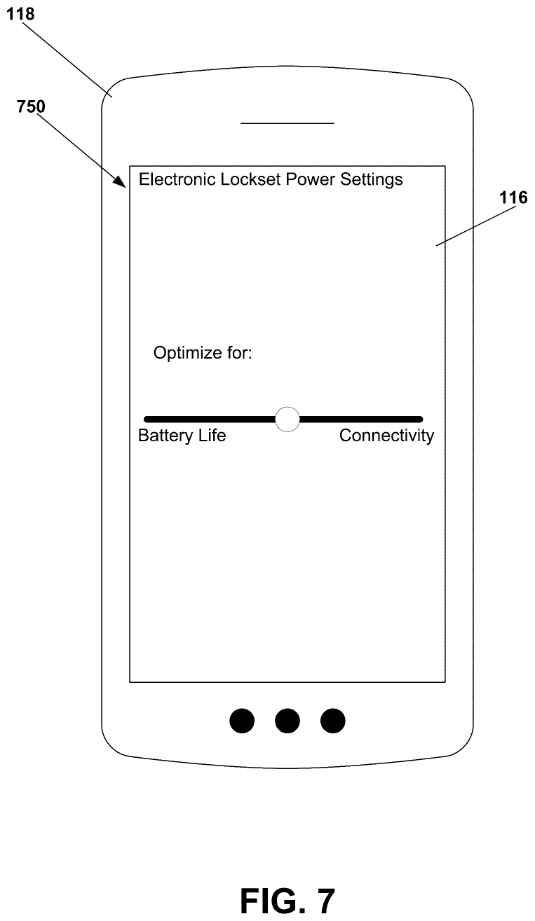

The operation 704 scans for the high-bandwidth wireless network and the low-power wireless network. The operation 706 detects a signal strength for the high-bandwidth wireless network and a signal strength for the low-power wireless network. The operation 708 recommends a default network based at least in part on the signal strength for the high-bandwidth network and the signal strength for the low-power network. In some embodiments, the operation 708 receives an optimization goal from the user indicating whether the user would prefer to prioritize remote connectivity with the electronic lockset or if the user would prefer to preserve battery life (e.g., via the user interface illustrated in FIG. 7).

FIG. 7 illustrates an example user interface 750 of the client application 116. The user interface is 750 is shown on the user computing device 118. The user interface 750 allows a user to adjust the electronic lockset settings including an option indicating whether the user would like to optimize for battery life or connectivity. In some examples, if a user would like to maximize connectivity, the high-power wireless network is selected as the default network and the low-power wireless radio placed in a power savings mode (e.g., for later activation as a failover network). If the user would like to optimize for battery life, then the low-power wireless network is selected as default.

In some embodiments, the electronic lockset may periodically use the high-bandwidth network to access the cloud environment and check for non-critical data such as diagnostic data, generate data, and over the air updates. In some embodiments, the period for performing these checks is based on the user's optimization preferences. For example, if a user would like to optimize for battery power, the check-in may occur daily, but if the user prefers to optimize for connectivity, the check-in may occur hourly. In some embodiments, the cloud environment updates the lock state (e.g., whether the door is open/closed and locked/unlocked) based on information received at each check-in.

### II. Failover Features

In some embodiments, the systems and methods disclose enable the configuration and operation for failover connectivity with continued remote access. In some embodiments, the electronic lockset is configured to operate using a default network (e.g., configured as part of the method 700 illustrated and describe in reference to FIG. 6) with the other network being in a standby mode. When a loss of connection with the default network is detected, the electronic lockset will wake up the radio in standby mode to provide connectivity via a second network.

In some embodiments, the electronic lockset may include more than two wireless network radios. For example, an example electronic lockset may include a first radio equipped to operate using the Wi-Fi protocol, a second radio equipped to operate the Thread protocol, and a third radio equipped to operate a Bluetooth and/or BLE protocol. Other combinations are also possible.

In some embodiments, the connection engine monitors the connectivity and if a connectivity failure is detected, the connection engine wakes-up the “standby” radio causing the standby radio to become active and provide connectivity. In some examples, the electronic lockset is capable of operating either using Wi-Fi or Matter/Thread, where Matter/Thread is default used to preserve battery power and Wi-Fi is used to provide fail over connectivity. In some embodiments, the electronic lockset may connect to a device using a third protocol (e.g., Bluetooth) when both the primary and standby options fail.

In some embodiments, the electronic lockset may operate in a proxy reporting mode. For example, when the electronic lockset determines that it cannot connect to the high-bandwidth network, the electronic lockset may operate in the proxy reporting mode. In the proxy reporting mode, the electronic lockset may advertise information (e.g., operating mode, battery information, connection information, etc.) over a low-power network, such as Bluetooth. A local user computing device can detect the advertised information and forward the updated information to a server (e.g., a server associated with a manufacturer or the electronic lockset or a third-party server). Remote users can then be informed of the updated information by the server.

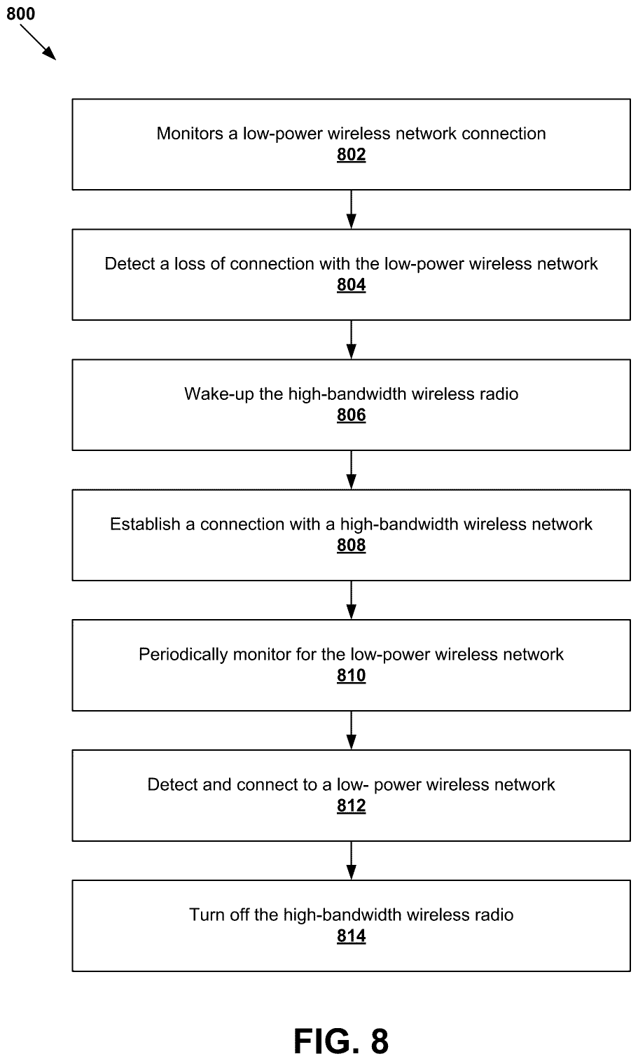

FIG. 8 illustrates an example method 800 for maintaining remote access when a low-power wireless network fails. In some embodiments, the method 800 is performed on an electronic lockset. The method 800 includes the operations 802, 804, 806, 808, 810, 812, and 814.

The operation 802 monitors a low-power wireless network connection. The operation 804 detects a loss of connection with the low-power wireless network. The operation 806 wakes up the high-bandwidth wireless radio. The operation 808 establishes a connection with a high-bandwidth wireless network via the high-bandwidth wireless radio. The operation 810 periodically monitors for the low-power wireless network. The operation 812 detects and connects to a low-power wireless network. The operation 814 turns off the high-bandwidth wireless radio.

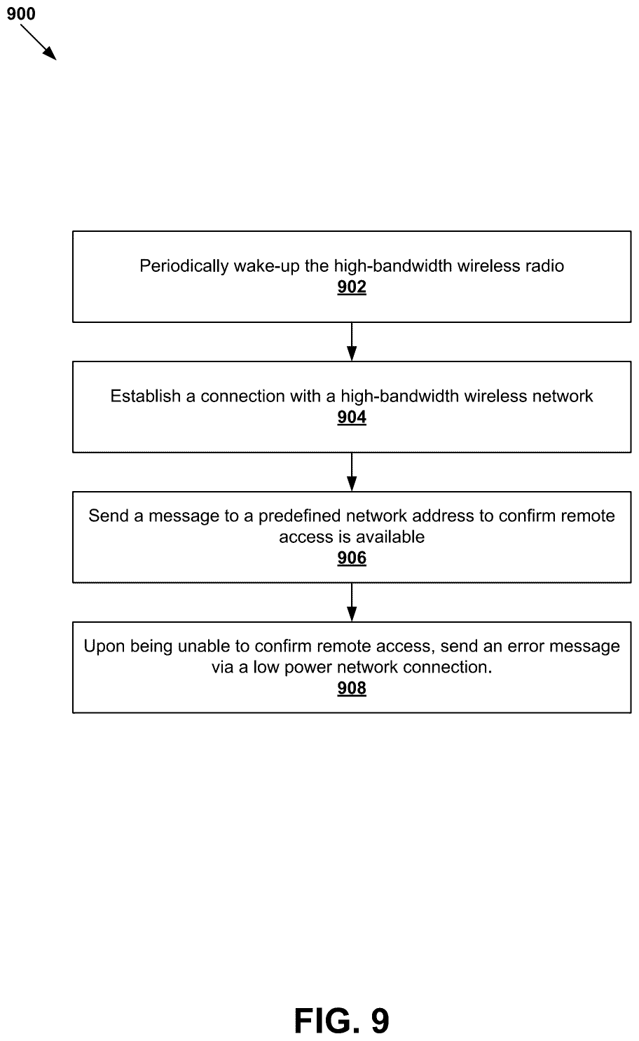

FIG. 9 illustrates an example method for monitoring high-bandwidth network connectivity while an electronic lockset is in a low-power state. In some embodiments, the method 900 is performed on the electronic lockset. The method 900 is performed to verify that connection to a high-bandwidth network is available and to notify the user if the ability to connect is lost. For example, a user may change a password for the high-bandwidth network but not notice the loss of connection to the electronic lockset because access is still available via the low-power wireless network. The method 900 includes the operations 902, 904, 906, and 908.

The operation 902 periodically wakes-up the high-bandwidth wireless radio. In some embodiments, the connection engine wakes-up the high-bandwidth wireless radio daily (e.g., every 24 hours). The operation 904 establishes a connection with a high-bandwidth wireless network. The operation 906 sends a message to a predefined network address to confirm that remote access is available. Upon being unable to confirm that remote access is available, the operation 908 sends an error message to the user computing device via the low-power network connection. In some embodiments, the error message allows the user to fix the connection issue while maintaining remote access via the low-power network.

Referring to the method 900, in some embodiments, the connection engine operating on the electronic lockset operates to wake up the high-bandwidth radio (e.g., a Wi-Fi radio) to periodically establish the connection to an access point (e.g., of the cloud environment or other application access point) to ensure the connection or route is not stale. In some embodiments, this method maintains the health of the standby network connection.

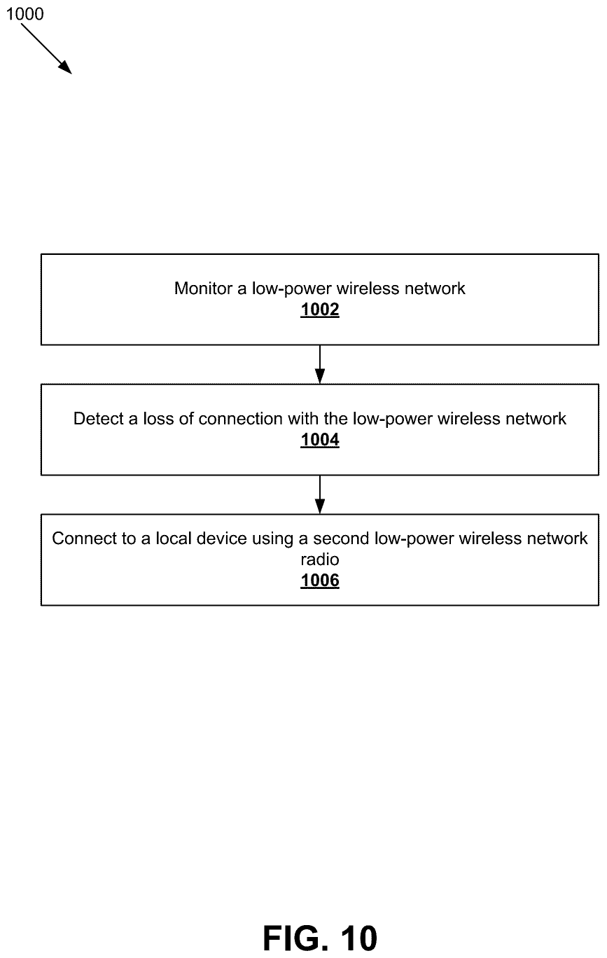

FIG. 10 illustrates an example method 1000 of using a second low-power wireless protocol when a first low-power network connection fails. In some embodiments, the method 1000 is performed on an electronic lockset. The method 1000 includes the operations 1002, 1004, and 1006.

The operation 1002 monitors a connection with a low-power wireless network. In some embodiments, the low-power wireless network uses the Thread protocol. The operation 1004 detects a loss of connection with the low-power wireless network. In some embodiments, at the operation 1004, the electronic lockset attempts and fails to connect to the high-bandwidth wireless network. For example, in the instance of a power outage, both the high-power wireless network and the low-power wireless network may fail as the hub devices lose power. The operation 1006 connects to a local device using a second-low power wireless network. For example, the operation 1006 may connect the electronic lockset to a mobile device of a user in proximity to the electronic lockset.

Referring to the method 1000, in some embodiments, the connection engine monitors the state of the primary network connection. If the primary connection fails, then the connection engine brings a failover wireless radio from a standby mode to an active mode to provide continuous remote access. In some embodiments, the primary radio is put into a standby mode until a user intervenes to reestablish the primary connection. Alternatively, the connection engine may monitor for the primary network connection and will automatically reestablish the connection once the primary network is detected.

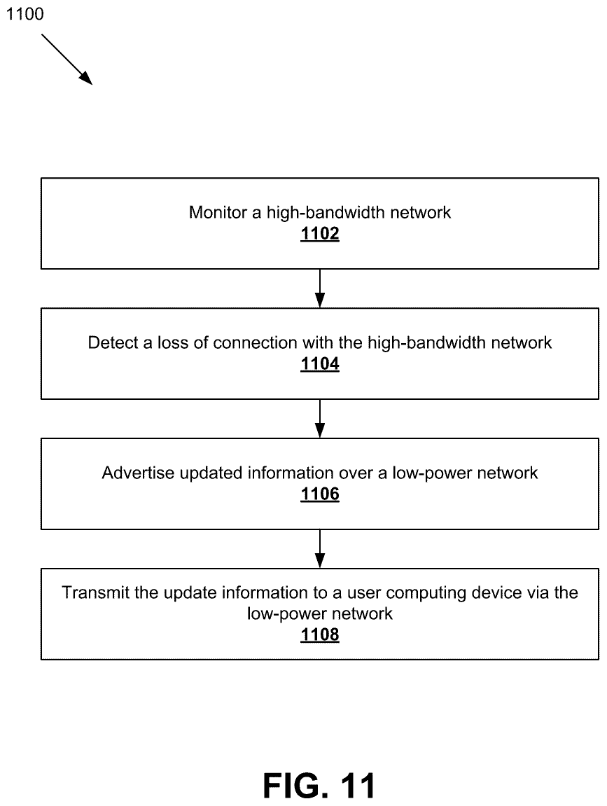

FIG. 11 illustrates an example method 1100 for performing proxy reporting from an electronic lockset. In some embodiments, the method 1100 is performed by the electronic lockset. The method 1100 includes the operations 1102, 1104, 1106, and 1108.

The operation 1102 monitors a high-bandwidth network. As described above in connection with FIG. 9, the electronic lockset may monitor a connection with the high-bandwidth network by periodically testing a connection to a predefined network address over the high-bandwidth network. The operation 1104 detects a loss of connection with the high-bandwidth network. For example, as described above, the electronic lockset may determine that it cannot connect to the predefined network address. In another example, as described further herein, the electronic lockset may determine that it cannot connect to the high-bandwidth network because the high-bandwidth radio has been disabled when the electronic lockset entered a low battery mode.

The operation 1106 advertises updated information over a low-power network, such as a Bluetooth network. Examples of updated information include an operating mode of the electronic lockset, battery information, and connection information. The operation 1108 includes transmitting the updated information to a user computing device via a the low-power network. The user computing device can the transmit the updated information to a server so that remote users can be informed of the updated information. For example, the server may transmit the updated information to a remote user computing device.

### III. Feature Set Protocol Parity

FIG. 12 illustrates an example operating environment 100 for providing remote access to the electronic lockset 102. The operating environment 100 includes an electronic lockset environment 101, a cloud environment 112, a third-party cloud environment 1030, and a user computing device 118.

Examples of the electronic lockset environment 101 including the electronic lockset 102, the connection engine 103, the door 104, the high-bandwidth network hub 106, the low-power network hub 108, and the network access device 110 are illustrated and described in reference to FIG. 1. Examples of the cloud environment 112, the server 114, and the client application 116 are also illustrated and described in reference to FIG. 1.

In some examples, an internet service provider (ISP) of the user may not support a connection between the low-power network hub 108 and the cloud environment 112. For example, if the low-power network is a Matter enabled network and the ISP does not support IPv6, then the electronic lockset 102 may be unable to connect to the cloud environment 112 via the low-power network hub 108. In these examples, the electronic lockset 102 is able to connect to the cloud environment 112 via the high-bandwidth network. In some of these examples, the electronic lockset 102 may be able to connect with a third-party cloud environment 1030. In some of these embodiments, the connection engine 103 operates to optimize power consumption while maintaining connectivity.

In some examples, the connection engine 103 may place the electronic lockset 102 in different modes depending on the battery state and/or user preference. The connection engine 103 will default place the high-bandwidth wireless radio in a power saving mode when in the low power mode. In some examples, when a low power mode is desired, the connection engine 103 may periodically turn on the high-bandwidth wireless radio of the electronic lockset 102 to check for updates. For example, the cloud environment 112 may be periodically probed for diagnostic data, general data, and over the air updates. In some embodiments, when the lockset 102 is in a low power mode, the connection engine 103 may turn on the high-bandwidth wireless radio in response to send critical data, such as low battery or lock tampering. In some embodiments, the client application 116 will notify the user that remote access of the electronic lockset 102 is unavailable via the client application 116 and instruct the user to open a third-party application 1040 to receive remote access.

The connection engine 103 may be further configured to place the electronic lockset 102 in a high-power mode, where the low-power wireless radio is put in a power saving mode and the high-bandwidth wireless network radio is active to provide remote access via the client application 116.

In some embodiments, the cloud environment 112 and the third-party cloud environment 1030 are in authorized communication in order to implement one or more electronic lock features including remote access, automations, and notification tracking. In some embodiments, one of or both of the cloud environment 112 and the third-party cloud environment 1030 publishes an API which enables authorized communication between the cloud applications. In some embodiments, one of or both of the third-party cloud environment 1030 and the cloud environment 112 are configured to send notifications. For example, status notifications, control notifications, or notifications related to other features.

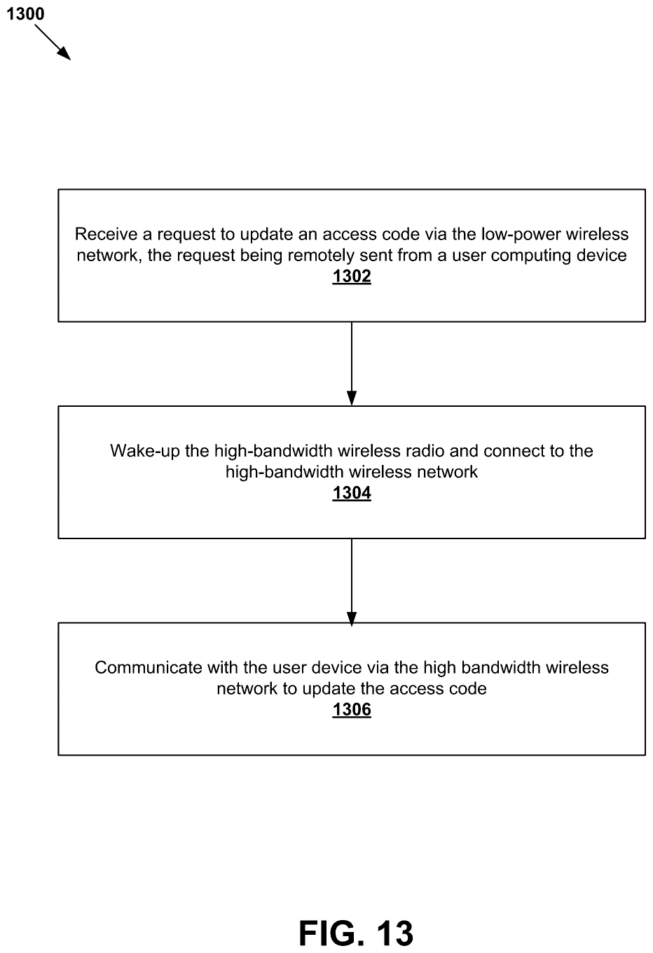

FIG. 13 illustrates an example method 1300 for waking up a high-bandwidth network to provide an updated access code to an electronic lockset. In some embodiments, the method 1300 is performed on the electronic lockset. The method 1300 includes the operations 1302, 1304, and 1306.

The operation 1302 receives a request to update an access code via the low-power network, the request being remotely sent from a user computing device (e.g., the user computing device 118). For example, the electronic lockset may be enabled with a low-power protocol which is unable to update the passcode but is able to receive an indication to wake up the high-power wireless radio. The operation 1304 wakes up the high-bandwidth wireless radio and connects to the high-bandwidth wireless network, and the operation 1306 communicates with the user computing device via the high-bandwidth wireless network to update the access code. Other remote access features can also be providing using methods similar to the method 1300.

### IV. Battery Conservation Features

In some embodiments disclosed herein, the electronic lockset is configured to limit or avoid the operation of more than one wireless radio at the same time. The networking connectivity procedures disclosed herein optimize the use of battery power while proving a full feature set for the electronic lockset. In some embodiments, the electronic lockset will monitor the connection strength of multiple wireless networks and connect to the network which optimizes battery use. In some embodiments, the electronic lockset is configured to minimize the use of a high-bandwidth wireless radio. For example, the high-bandwidth wireless radio may be limited to use for critical events. In some embodiments, the electronic lockset optimizes the operation of the more than one wireless radio by (1) ensuring only one wireless radio is active at a given time; and (2) minimizing the use of the wireless radio which requires more power.

In embodiments, to conserve battery when the battery level is low (e.g., below a predetermined threshold), the electronic lockset may enter a low battery mode in which the high-bandwidth radio is disabled. Because operation of the high-bandwidth radio requires more power consumption than operation of the low-power radio, disabling the high-bandwidth radio when the electronic lockset is in the low battery mode may extend the battery life of the electronic lockset by days or weeks. When the battery level increases back above the threshold, the electronic lockset may exit the low battery mode. Additionally, in some embodiments, the electronic lockset may be programmed with one or more battery notification thresholds. In an example, when the battery level drops below a battery notification threshold, the electronic lockset transmits a notification to a server or a user computing device that be battery is getting low. In embodiments, the battery notification thresholds are higher than the threshold at which the electronic lockset enters the low battery mode.

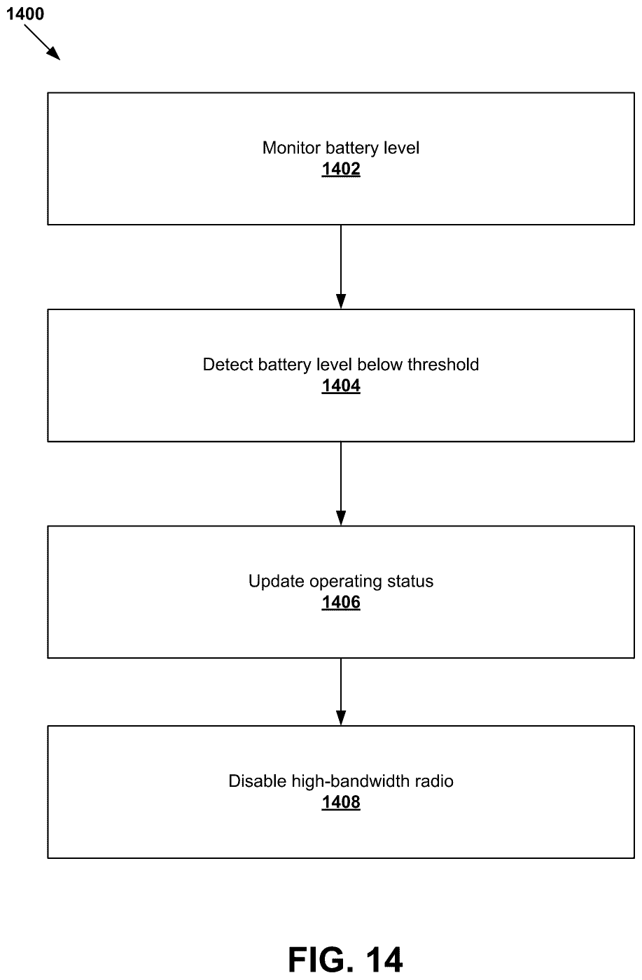

FIG. 14 illustrates an example method 1400 for transitioning an electronic lockset into a low battery mode. In some embodiments, the method 1400 is performed on the electronic lockset. The method 1400 includes the operations 1402, 1404, 1406, and 1408.

The operation 1402 monitors the battery level of the electronic lockset. For example, the battery level of the electronic lockset may be checked every 48 hours. The operation 1404 detects that the battery level of the electronic lockset is below a predetermined threshold. In an example, the threshold is ten percent of the maximum capacity of the battery. In some embodiments, the threshold may be configurable by a user. For example, the user may set the threshold through a client application executing on a user computing device, and the user computing device may transmit the updated threshold to the electronic lockset (e.g., via the high-bandwidth network or the low-power network). When the electronic lockset detects that the battery level is below the threshold, the electronic lockset may transition to the low battery mode.

The operation 1406 updates an operating status of the electronic lockset. In an example, the electronic lockset transmits an update to a server (e.g., a server associated with a manufacturer of the electronic lockset or a third-party server) indicating that the electronic lockset is entering the low battery mode. The server may then update a user that the electronic lockset is transitioning to the low battery mode. For example, the server may send a notification to a client application operating on a user computing device. Because the user computing device is informed that the electronic lockset has entered the low battery mode, the user computing device will know to use a low-power network to communicate with the electronic lockset.

The operation 1408 disables the high-bandwidth radio in the electronic lockset. However, the electronic lockset can still be controlled through the low-power radio in the electronic lockset (e.g., the electronic lockset can be controlled via a Bluetooth connection). Because the high-bandwidth radio is disabled, the battery life of the electronic lockset is extended while in the low battery mode.

In alternative embodiments, the operations of the method 1400 may be performed in a different order. For example, the high-bandwidth radio may be disabled (operation 1408) prior to updating the operating status of the electronic lockset (operation 1406). In an example, a proxy reporting process is used to update the operating status of the electronic lockset without using the high-bandwidth radio to communicate with the server. In the proxy reporting process, the electronic lockset may communicate the operation status to a user computing device via a low-power network (e.g., Bluetooth). The user computing device can then act as a proxy to update the server that the electronic lockset has transitioned to the low battery mode. By using the user computing device as a proxy to update the server of the operating status of the electronic lockset, the battery life of the electronic lockset can be further extended by reducing the number of communications from the electronic lockset using the high-bandwidth radio.

### V. Feature Set Protocol Parity Use Cases

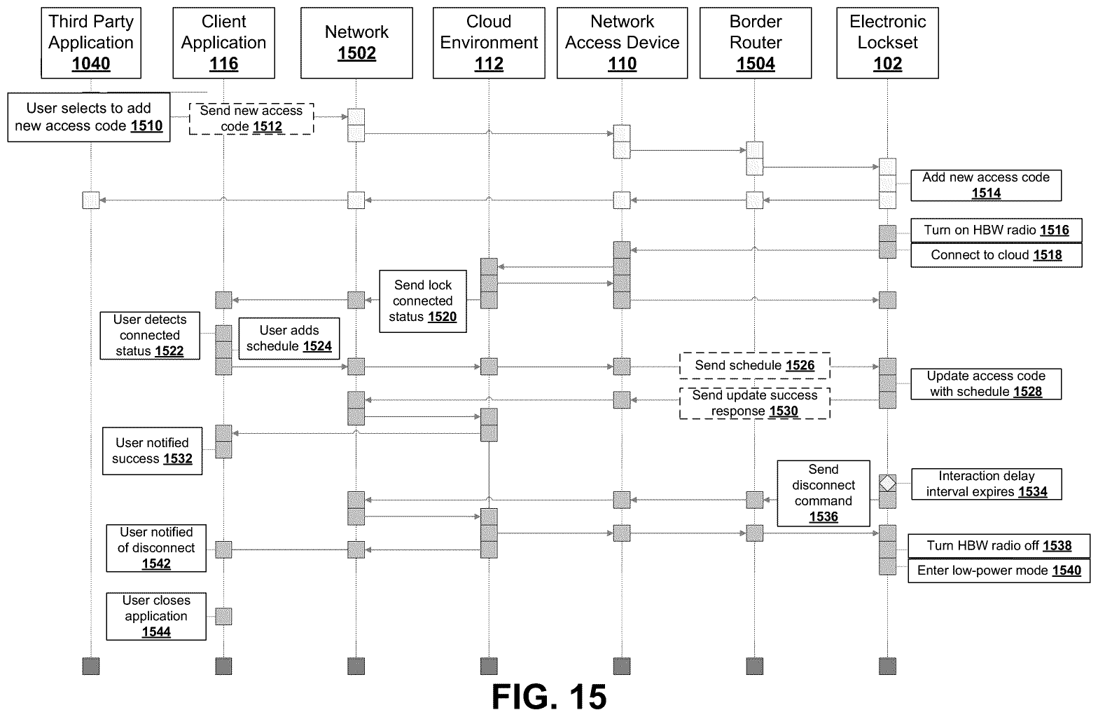

FIGS. 15-17 illustrate different use cases where the electronic lockset wakes up/activates the high-bandwidth wireless radio to implement a feature. Each of FIGS. 15-17 illustrate a specific use case. However, a person of ordinary skill in the art would recognize that analogous use cases could be implemented using the same or similar processes.

In some embodiments, a capability of a low-power mobile application triggers the activation of the high-bandwidth wireless radio based on an inference of the user's intent. For example, a subset of features which are available via the low-power layer (e.g., available over matter) may be indicative of a user intending to use a feature that is only available over the high-bandwidth network layer. In these examples, an interaction over the low-power network with one of these features triggers the electronic lockset to activate its high-bandwidth wireless radio. In some of these examples, a user may be notified to access the client application to access the electronic lockset in order to use the feature that is inferred that the user would like to access based on the interaction with a feature over the low-power network. In some of these examples, the client application communicates over the high-bandwidth network layer, leveraging the high-bandwidth wireless radios that were initiated based on the user's interactions on the low-power network application layer. An advantage of this use case includes allowing for more extensive and flexible interactions with the electronic lockset, as inferred in the background based on the user's interactions. One example of such a use case is illustrated and described in reference to FIG. 15.

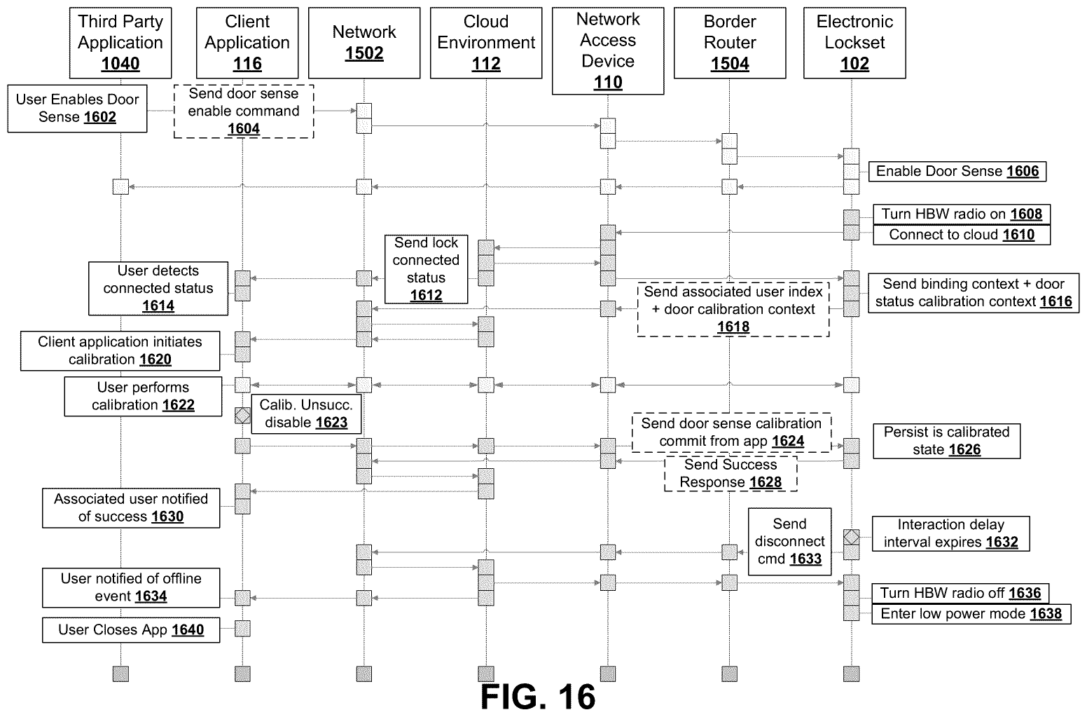

In some embodiments, a low-power mobile application triggers support for a separate high-bandwidth application based on the inference of user intent specific to an associated client application. The association between a third-party application and a client application is established during an activation process of the lockset and/or a sharing (or “connection”) process between the applications. When a user has access to a third-party application that can control a subset of settings and/or features of a low-power application protocol, the remote device is triggered to wake up the high-bandwidth radios when the user interacts with one of the subset of settings and/or features. In some embodiments, the third-party application notifies the client application to provide information about the event's context, smoothly integrating the client application into the workflow of the third-party application. In some of these embodiments, the third-party application is an application which uses the low-power wireless network layer and the client application is an application which uses the high-bandwidth wireless network layer. One example of such a use case is illustrated and described in reference to FIG. 16.

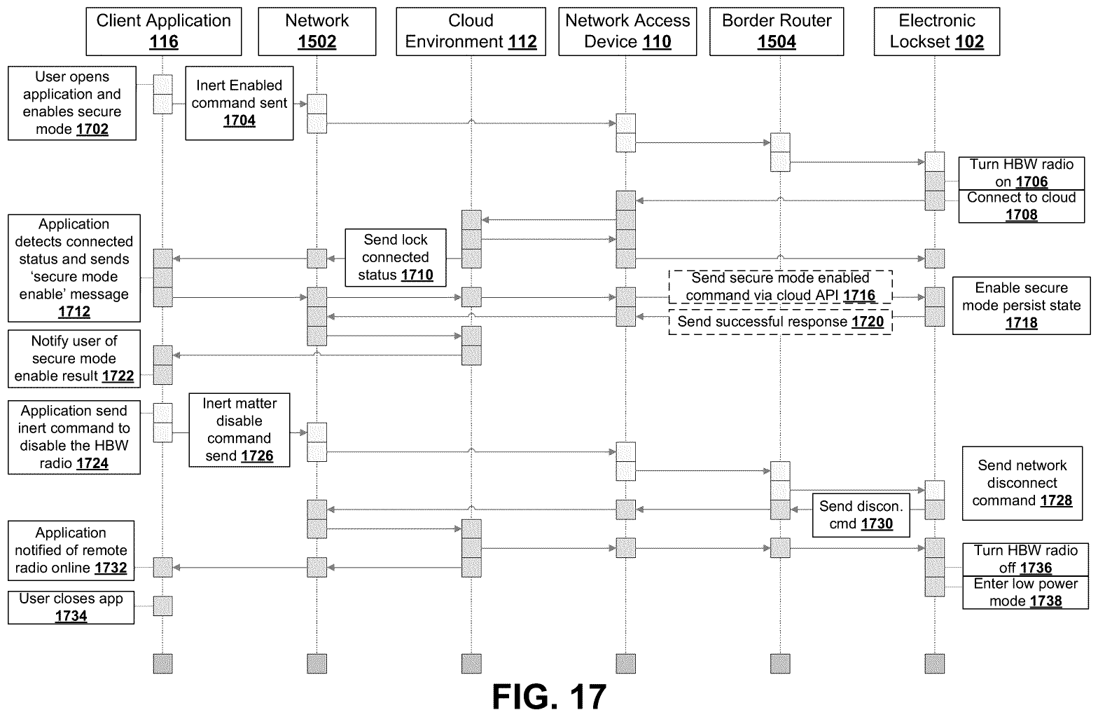

In some embodiments, a mobile application with low-power network and high-bandwidth network control leverages the states of inert settings in the low-power APIs to active access to the high-bandwidth APIs of the electronic lockset. For example, a user of a mobile application with the ability to send commands through multiple protocols can utilize unused settings/fields or values in the low-power protocol to indicate to the electronic lockset a desire to access features only available in the high-bandwidth APIs. The electronic lockset responds to receiving a command at one of the unused settings/fields by enabling the high-bandwidth wireless radios in the device, allowing the application to control features not accessible through the low-power API/protocol. In some examples, the application's user interface/experience seamlessly extends the lock's control capabilities while the user progress through the regular workflow of changing the electronic lockset's configuration. Once the user completes the workflow, the application and electronic lockset revert to the low-power mode. One example of such a use case is illustrated and described in FIG. 17.

FIG. 15 illustrates an example system-flow diagram illustrating a process for updating an access code of an electronic lockset with multiple wireless radios. The system-flow diagram includes a third-party application 1040, a client application 116, a network 1502, a cloud environment 112, a network access device 110, a border router 1504, and an electronic lockset 102.

Examples of the third-party application 1040, client application 116, cloud environment 112, network access device 110, and electronic lockset 102 are described herein. The network 1502 is configured to connect a mobile device executing the third-party application 1040 and client application 116 with the cloud environment 112 and electronic lockset 102 (e.g., indirectly via the network access device 110 and the border router 1504). In some embodiments, the network 1502 is a public network, such as an Internet. In some embodiments, the border router 1504 is a Matter enabled device which connects the electronic lockset 102 to a Matter based network.

In one non-limiting example, a user attempts to add a new access code to the electronic lockset 102 via a third-party application 1040 when the electronic lockset 102 is in a low-power mode (e.g., only connected via matter). The access code is sent to the electronic lockset 102 using a low-power network, and the lockset 102 activates the high-bandwidth network to connect with a cloud application associated with the client application 116. The user is then able to use the client application 116 to add a schedule which is sent to the electronic lockset 102 via the high-bandwidth network. The updated schedule is confirmed with the client application 116, the user can close or move away from the client application 116, and the lock 102 turns off the high-bandwidth radio to disconnect form the high-bandwidth wireless network once an interaction delay interval expires. At this point, the lock 102 is reverted to a low power mode.

The example process illustrated in FIG. 15 begins at the operation 1510 when a user attempts to add a new access code at the user's mobile device for the electronic lockset 102. The operation 1512 sends the new access code to the electronic lockset 102 over the network 1502 to the network access device 110, where the lockset 102 ultimately receives the message via a low-power network, and adds the access code at the operation 1514 and sends a confirmation to the third-party application 1040. In the example shown, the add access code command is one which is indicative that the user may like to access additional features related to the access code, for example to add a schedule where the new access code is enabled. However, in the example shown, such a feature is not available over the low-power network and the electronic lockset 102 turns on the Wi-Fi radio at operation 1516 and connects to the cloud environment 112 at operation 1518. In some embodiments, at operation 1520, the cloud application at the cloud environment 112 sends a lock connected status notification to the mobile device to initiate the user to open the client application 116. In other embodiments, the user opens the client application 116 and then notices—at operation 1522, for example—that the electronic lockset 102 is in a connected state. The user is then prompted to add a schedule for the access code at the operation 1524 and send the schedule, using the high-bandwidth network, at operation 1526. The lock 102 updates the new access code with the schedule at operation 1528 and sends an update success response to the client application 116 at the operation 1530. The client application 116 notifies the user of the successful update at the operation 1532. In response to an interaction delay interval expiring at the operation 1534, the electronic lockset 102 sends a disconnect command at the operation 1536 to the client application 116. The client application 116 notifies the user that the electronic lockset 102 is going to disconnect from the high-bandwidth network at the operation 1544. At operation 1538, the electronic lockset 102 turns off the Wi-Fi radio and at operation 1540, the electronic lockset 102 enters a low-power mode. In some embodiments, the user closes the client application 116 at operation 1544.

FIG. 16 illustrates an example system-flow diagram illustrating a process for enabling door sense of an electronic lockset with multiple wireless radios. The system-flow diagram shows a third-party application 1040, a client application 116, a network 1502, a cloud environment 112, a network access device 110, a border router 1504, and an electronic lockset 102, examples of which are described herein.

In some examples, a user selects to enable door sense capability (e.g., open-close detection and/or locked-unlocked detection) using the third-party application 1040. In some of these examples, the electronic lockset 102 is unable to support lock calibration requirements on the low-power network. In the example shown, the electronic lockset 102 activates the high-bandwidth wireless radio to connect with the cloud environment 112. Once connected, the lock 102 sends the door sense context along with the associated user index, ensuring that only the client attempting to change the door status is notified. This notification prompts the client application 116 to switch its context to support the calibration activities. After the calibration process is completed successfully or unsuccessfully, the lock 102 updates the third-party application 1040 with the appropriate status of the door.

In the example shown, at operation 1602, the user enables door sense and the third-party application 1040 sends the door sense enable command, at operation 1604, via the network 1502 to the network access device 110 which sends the command via the border router 1504 to the electronic lockset 102 over the low-power network. The electronic lock 102 may activate door sense at the operation 1606 but determines that it must connect to the cloud to perform the calibration process. At operation 1608, the electronic lockset 102 turns on the high-bandwidth radio and connects to the cloud environment 112 at operation 1610. At operation 1612, the cloud environment 112 sends a connected status to the client application 116 to notify the user of the connected status at operation 1614. At operations 1616 and 1618, the electronic lockset 102 sends a binding context and door status calibration context to the client application 116. At operation 1620, the client application 116 initiates calibration and at operation 1622, the user performs calibration. If the calibration is unsuccessful, then door sense is disabled at operation 1623. Otherwise, the client application 116 sends a door sense calibration commit via the high-bandwidth network from the client application 116 at operation 1624 and the lock 102 enters a calibrated state at operation 1626. After the lock 102 enters the calibrated state, the electronic lockset 102 sends a successful calibration response to the client application 116 via the high-bandwidth network connecting via the network access device 110 to the cloud environment 112. The client application 116 notifies the user of successful calibration at operation 1630. At operation 1632, the interaction delay interval expires at the electronic lockset 102 and at operation 1633, the electronic lockset 102 sends the disconnect command via the low-power network. The electronic lockset 102 turns off the high-bandwidth wireless radio at operation 1636 and enters the low-power mode at operation 1638. The client application 116 notifies the user of the disconnect event at operation 1634 and the user may close the client application 116 at operation 1640.

FIG. 17 illustrates an example system-flow diagram illustrating a process for enabling a secure mode at an electronic lockset with multiple wireless radios. The system-flow diagram shows a client application 116, a network 1502, a cloud environment 112, a network access device 110, a border router 1504, and an electronic lockset 102, examples of each are described herein.

In one example, a user may desire to modify the “secure mode” on the electronic lockset 102 lock screen, where the secure mode is not available over the protocol of the low-power network. In response to the selection, the client application 116 sends a command that is valid from the protocol perspective but unsupported by the electronic lockset 102 or the ecosystem (e.g., a Matter ecosystem). When the command is received at the electronic lockset 102, it triggers the electronic lockset 102 to activate the high-bandwidth wireless radio and to connect the electronic lockset 102 to the cloud environment 112. The client application 116 then receives the connected status and sends the secure mode command to the electronic lockset 102 over an API available via the high-bandwidth network. When the electronic lockset 102 receives the secure mode command, it disables the touch screen. In some examples, the electronic lockset 102 stays connected with the cloud environment 112 until it receives a user feature connection disable command causing the lock 102 to return to the low-power mode of operation. In some embodiments, the connection disable command is sent over the low-power wireless network.

In the example shown, the user opens the client application 116 and enables secure mode at operation 1702 and sends an inert enabled command to the electronic lockset 102 at operation 1704. The command is received at the network access device 110 which sends the command via the border router 1504 to the electronic lockset 102 over the low-power wireless network. Operation 1706 triggers the electronic lockset 102 to turn on the high-bandwidth wireless radio and to connect to the cloud environment 112 via the high-bandwidth wireless network at operation 1708. The cloud environment 112 sends a lock connected status to the client application 116 at operation 1710. The client application 116 detects the connected status and sends the ‘secure mode enable’ message to the electronic lockset 102 at operation 1712. The message is sent to the electronic lockset 102 via the high-bandwidth wireless radio using the cloud API at operation 1716. The electronic lockset 102 enables secure mode at operation 1718 and sends a successful response via the high-bandwidth network at operation 1720. The client application 116 notifies the user of the secure mode enable result at operation 1722. The client application 116 sends an inert command to disable the high-bandwidth radio at operations 1724 and 1726. In the example shown, the command is sent via the low-power wireless network. The electronic lockset 102 receives the command and sends a disconnect command at operations 1728 and 1730. The client application 116 notifies the user that the high-bandwidth radio is offline at operation 1732 and the user may close the client application 116 at operation 1734. The electronic lockset 102 turns off the high-bandwidth radio at operation 1736 and enters the low-power mode at operation 1738.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. An electronic lockset comprising:
an exterior subassembly;
an interior subassembly including:
a control circuit and a motor actuatable by the control circuit;
a high-bandwidth wireless radio configured to connect to a high-bandwidth wireless network; and
a low-power wireless radio configured to connect to a low-power wireless network; and
a latch operatively connected to the interior subassembly, the latch being engageable by the motor to move the electronic lockset between a locked state and an unlocked state,
wherein the control circuit monitors connection of at least one of the high-bandwidth wireless network and the low-power wireless network and places one of the high-bandwidth wireless radio and the low-power wireless radio in a power saving mode while maintaining remote access capability.

2. The electronic lockset of claim 1, wherein in a default mode, the electronic lockset is connected to the low-power wireless network and the high-bandwidth wireless radio is in the power saving mode.

3. The electronic lockset of claim 2, wherein upon the control circuit detecting a loss of connection with the low-power wireless radio, the control circuit activates the high-bandwidth wireless radio to connect to the high-bandwidth wireless network and transmits an alert notification indicating a loss of connection with the low-power wireless network to a computing device associated with an authorized user of the electronic lockset.

4. The electronic lockset of claim 3, wherein the control circuit monitors for the low-power wireless network via the low-power wireless radio and upon detection and connection to the low-power wireless network, places the high-bandwidth wireless radio in the power saving mode.

5. The electronic lockset of claim 2, wherein the control circuit is configured to:
periodically wake up the high-bandwidth wireless radio;
establish a connection with the high-bandwidth wireless network via the high-bandwidth wireless radio; and
send a message to a predefined network address to confirm remote access with the electronic lockset is available via the high-bandwidth wireless network.

6. The electronic lockset of claim 5, wherein upon being unable to confirm that remote access is available via the high-bandwidth wireless network, the control circuit is configured to send an error message to a user device associated with an authorized user of the electronic lockset via the low-power wireless network.

7. The electronic lockset of claim 5, wherein upon confirming remote access with the electronic lockset, the control circuit accesses a cloud application via the high-bandwidth wireless network to check for a firmware update.

8. The electronic lockset of claim 5, wherein upon confirming remote access with the electronic lockset, the control circuit places the high-bandwidth wireless radio in the power saving mode.

9. The electronic lockset of claim 1, wherein the low-power wireless network is a wireless mesh network implemented using a Thread protocol.

10. The electronic lockset of claim 1, wherein the low-power wireless network is a Bluetooth Low Energy (BLE) network and the high-bandwidth wireless network is a Wi-Fi network.

11. The electronic lockset of claim 1, wherein remote access of the electronic lockset is provided by at least one of a first cloud application associated with a manufacturer of the electronic lockset and a second cloud application associated with a third party,
wherein only the second cloud application is able to access the electronic lockset when the electronic lockset is connected via the low-power wireless network and the high-bandwidth wireless radio is in the power saving mode, and
wherein the first cloud application is able to send a notification to wake up the high-bandwidth wireless radio to remotely access the electronic lockset in response to a user selecting a feature to remotely update a passcode for the electronic lockset, wherein the feature requires the first cloud application.

12. The electronic lockset of claim 1, wherein the electronic lockset includes a third wireless radio, wherein the third wireless radio is configured provide connectivity when a connection with the high-bandwidth wireless network fails and a connection with the low-power wireless connection fails.

13. A user computing device for configuring an electronic lockset, the user computing device comprising:
at least one processor; and
at least one memory storing instructions which, when executed by the at least one processor, cause the user computing device to:
wirelessly pair with the electronic lockset;
determine whether a local environment is equipped for the electronic lockset to connect to at least one of a high-bandwidth wireless network or a low-power wireless network; and
provide credentials to enable the electronic lockset to connect to at least one of the high-bandwidth wireless network or the low-power wireless network.

14. The user computing device of claim 13, wherein to determine whether the local environment is equipped for the electronic lockset to connect to the low-power wireless network is based at least in part on whether a Wi-Fi router in the local environment is IPv6 compatible.

15. The user computing device of claim 13, wherein to determine whether the local environment is equipped for the electronic lockset to connect to the low-power wireless network is based at least in part on whether the user computing device can detect a low-power wireless network hub in the local environment, and wherein the low-power wireless network hub is a Matter enabled device.

16. The user computing device of claim 13, wherein upon determining the local environment is equipped with only one of the high-bandwidth wireless network and the low-power wireless network, the electronic lockset is configured to place a wireless radio associated with the wireless network that is not equipped in the local environment in a power saving mode.

17. The user computing device of claim 16, wherein upon determining the local environment is equipped with both the high-bandwidth wireless network and the low-power wireless network, the electronic lockset is configured determine a default network based, at least in part, on a user selection for a desired optimization goal between optimization for battery power and optimization for connectivity,
wherein the electronic lockset places the wireless network which is not the default network in the power saving mode.

18. The user computing device of claim 13, wherein the user computing device operates a first application associated with a manufacturer of the electronic lockset and a second application associated with a third party,
wherein connecting the electronic lockset to the low-power wireless network includes enrolling the electronic lockset with a third-party application.

19. An electronic lockset comprising:
an exterior subassembly;
an interior subassembly including:
a control circuit and a motor actuatable by the control circuit;
a high-bandwidth wireless radio configured to connect to a high-bandwidth wireless network; and
a low-power wireless radio configured to connect to a low-power wireless network; and
a latch operatively connected to the interior subassembly, the latch being engageable by the motor to move the electronic lockset between a locked state and an unlocked state, wherein the control circuit monitors connection of at least one of the high-bandwidth wireless network and the low-power wireless network and places one of the high-bandwidth wireless radio and the low-power wireless radio in a power saving mode while maintaining remote access capability,
wherein the electronic lockset is configured to transition to a low battery mode in response to determining that a battery level is below a predetermined threshold, wherein the high-bandwidth wireless radio is disabled while the electronic lockset is in the low battery mode.

20. The electronic lockset of claim 19, wherein the electronic lockset is further configured to:
while in the low battery mode, transmit updated information to a local computing device using the low-power wireless radio, wherein the computing device is configured to transmit the updated information to a server for transmission of the updated information to a remote computing device.
